(19) United States
(12) Patent Application Publication
(10) Pub. No.: US 2010/0175762 A1
(43) Pub. Date: Jul. 15, 2010

(54) Washing machine flood prevention system

(76) Inventor: Carl G. Anacrelico, Floral Park, NY (US)

Correspondence Address: LITMAN LAW OFFICES, LTD., POST OFFICE BOX 41200, SOUTH STATION, ARLINGTON, VA, 22204, US

(21) Appl. No.: 12/318,911

(22) Filed: Jan. 12, 2009

(51) Int. Cl. A47L 15/42; F16K 31/18

(52) U.S. Cl. 137/387; 137/409

(57) ABSTRACT

The washing machine flood prevention system provides an interruptible power supply to a washing machine. In the event of potential flooding by the washing machine, power to the washing machine is interrupted and an alarm is delivered to the user. The washing machine flood prevention system includes a control box housing a control circuit. The control circuit includes at least one alarm and a power outlet adapted for receiving the electrical plug of the washing machine. A water level sensor, such as a float switch, is in communication with the control circuit. A ground fault circuit interrupter is in electrical communication with the control circuit. The ground fault circuit interrupter provides interruptible electrical power to the control circuit and the washing machine. The electrical power is interrupted if a control signal is generated by the water level sensor responsive to a flood.

### BACKGROUND OF THE INVENTION

1. Field of the Invention

The present invention relates to interruptible power supplies for washing machines, and more particularly to a washing machine flood prevention system that interrupts power to the washing machine responsive to a control signal sent by a water level sensor in the event of an overflow

2. Description of the Related Art

Automatic washing machines often cause floods due to drain lines or drainage sinks, which collect periodic waste water, become obstructed or clogged, and overflow. Typically, the user of an automatic washing machine may not be in the vicinity of the washing machine when the drain standpipe or sink becomes clogged, thus allowing a substantial amount of water spillage on the surrounding floor area, which can cause damage to surrounding items and to the floor and covering. Such flooding is time-consuming and expensive to fix.

Thus, a washing machine flood prevention system solving the aforementioned problems is desired.

### SUMMARY OF THE INVENTION

The washing machine flood prevention system provides an interruptible power supply to a washing machine. In the event of potential flooding by the washing machine, power to the washing machine is interrupted, and an alarm is delivered to the user.

The washing machine flood prevention system includes a control box housing a control circuit. The control circuit includes at least one alarm and a power outlet adapted for receiving the electrical plug of the washing machine. The alarm preferably includes an auditory alarm. Additional alarms, such as a visual indicator or a cellular transmitter for sending a wireless alarm signal to the user's telephone, may further be utilized.

A water level sensor, such as a float switch, is in communication with the control circuit. The water level sensor is adapted for mounting within a drainage sink associated with the washing machine and generates a control signal if the water level in the drainage sink rises above a certain level. A second, floor-mounted water sensor may also be utilized if the washing machine leaks water on the floor. Alternatively, when the washing machine drains into a standpipe instead of a sink, a water sensor may be mounted onto a discharge hose of the washing machine to generate a control signal if the drain standpipe becomes obstructed.

The control circuit preferably further includes a visual power indicator, a control switch for selectively activating and deactivating the control circuit, a reset switch, a switch for selectively activating and deactivating the alarm, at least one fuse, and a step-down transformer.

A ground fault circuit interrupter (GFCI) is in electrical communication with the control circuit. The ground fault circuit interrupter provides interruptible electrical power to the control circuit and the washing machine if a ground fault is detected anywhere in the circuit. The electrical power is interrupted if the control signal is generated by the water level sensor responsive to a flood. The alarm is further actuated in response to the control signal.

These and other features of the present invention will become readily apparent upon further review of the following specification and drawings.

### BRIEF DESCRIPTION OF THE DRAWINGS

FIG. 1 is an environmental, perspective view of a washing machine flood prevention system according to the present invention.

FIG. 2 is a perspective view of the control unit of a washing machine flood prevention system according to the present invention.

FIG. 3 is a schematic diagram of an exemplary control circuit of the washing machine flood prevention system according to the present invention.

Similar reference characters denote corresponding features consistently throughout the attached drawings.

### DETAILED DESCRIPTION OF THE PREFERRED EMBODIMENTS

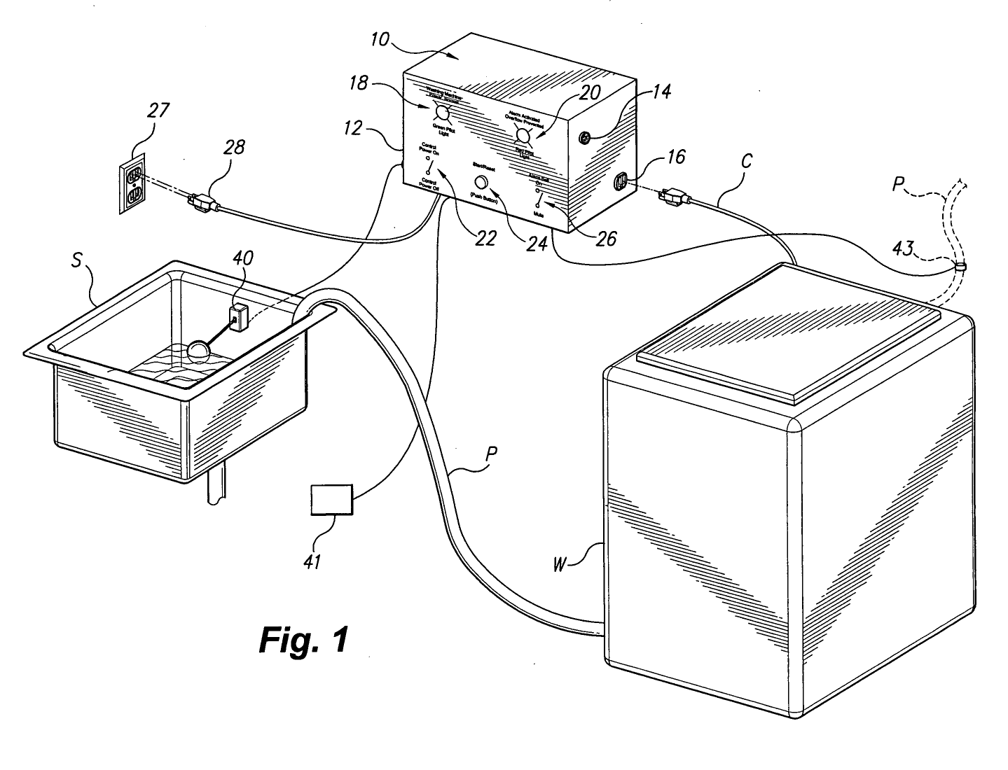

As best shown in FIG. 1, the washing machine flood prevention system 10 provides an interruptible power supply to a washing machine W. In the event of potential flooding by the washing machine W, power to the washing machine W is interrupted, and an alarm signal is delivered to the user. It should be understood that washing machine W is shown for exemplary purposes only, and that system 10 may be used in combination with any desired electrically-powered utility, e.g., a hot tub, dishwasher or the like.

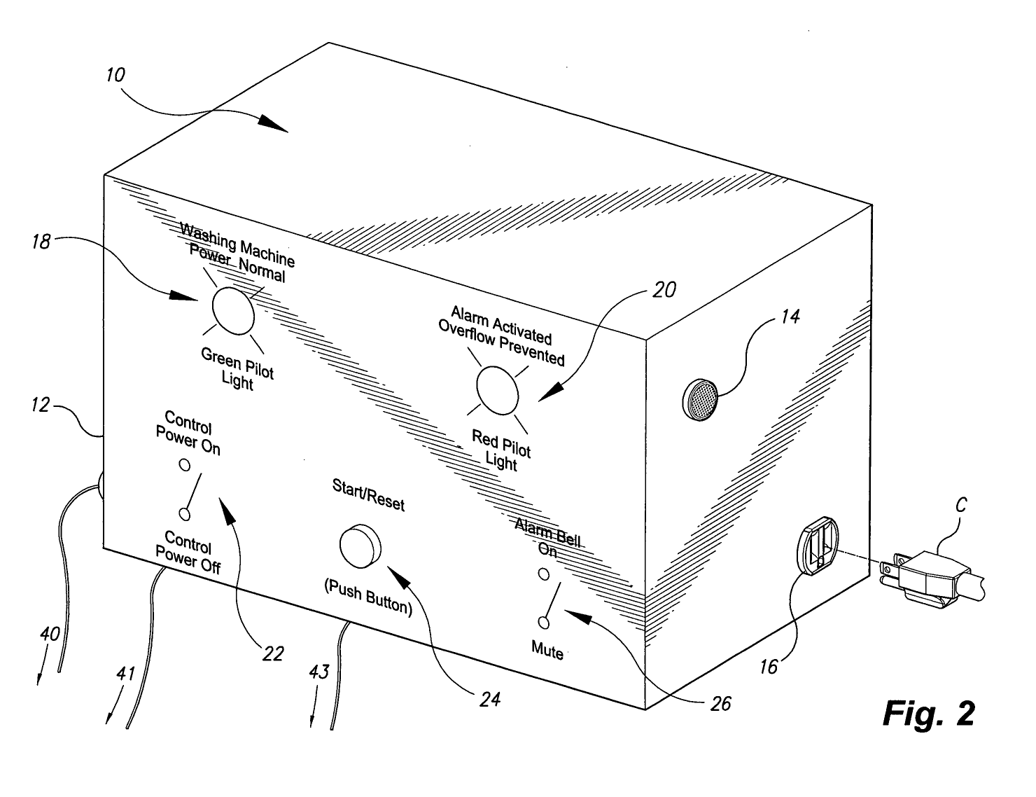

Referring to FIGS. 1 and 2, the washing machine flood prevention system 10 includes a control box or housing 12, which houses a control circuit. It should be understood that housing 12 is shown for exemplary purposes only, and that housing 12 may have any desired shape or dimensions. Housing 12 is preferably formed from a waterproof material.

The control box 12 has an audible alarm 14, such as a bell, a buzzer, or other device that emits an audible alarm, mounted within the control box 12. The housing includes an outlet 16, to which a power cord C of washing machine W may be connected.

The control box 12 may also have several buttons, switches, and indicator lights mounted thereon. As shown in FIG. 2, the control box may have a power-on visual indicator 18 to indicate that the control unit 12 is turned on and that power is being supplied to the outlet 16 that the washing machine W is connected to. The control box 12 may also have a visual alarm signal 20 to indicate that either the system has not yet been activated, or that a flood condition has been detected and power to the outlet 16 has been interrupted. The power visual indicator 18 and the visual alarm signal 20 may be any form of electronic visual indicator, including an incandescent lamp, a neon lamp, a light emitting diode, a liquid crystal display (LCD) screen, etc. Visual indicators 18 and 20 may have different color lenses, e.g., green and red, and the visual alarm indicator may either provide constant illumination or may be a flashing lamp or LED circuit.

The control box 12 may include a main power switch 22 to apply power to the primary control circuit. Power switch 22 may be a toggle switch, rotary switch, push button switch, or any suitable power switch. The control box 12 may have a start/reset switch 24, which is preferably a momentary push button switch, mounted thereon for silencing or turning off the alarms and applying power to the outlet 16. Finally, the control box 12 may optionally have a mute switch 26 for turning off any audible alarm while the user or a service technician attempts to locate and correct a fault condition.

Referring back to FIG. 1, the control unit 12 is preferably connected to a conventional 120-volt power outlet by a ground fault circuit interrupter (GFCI) plug 28 (cord plugs having built-in ground-fault protection are available for power tools, vending machines, major appliances, etc.), which provides additional protection against electrical shorts caused by faulty components coming into contact with water or other ground fault conditions. The washing machine W is connected to outlet 16 by its electrical cord C.

For those washing machines W that include a drain tube P that discharges waste water into a sink S, the control unit 12 is connected to an external water sensor, such as normally closed float switch 40, that detects when the water level in the sink S rises above a predetermined water level. Alternatively, for those washing machines that discharge waste water directly into a drain standpipe, the system 10 may include an external, normally closed water sensor switch 43 attached to the discharge pipe P or other conduit to detect overflows that may occur, e.g., when the drain standpipe is clogged, the switch 43 being electrically connected to the control unit 12. Optionally, the system 10 may include a normally closed floor-mounted water sensor switch 41 connected to the control unit 12 for detecting flooding of the floor where the washing machine W is located.

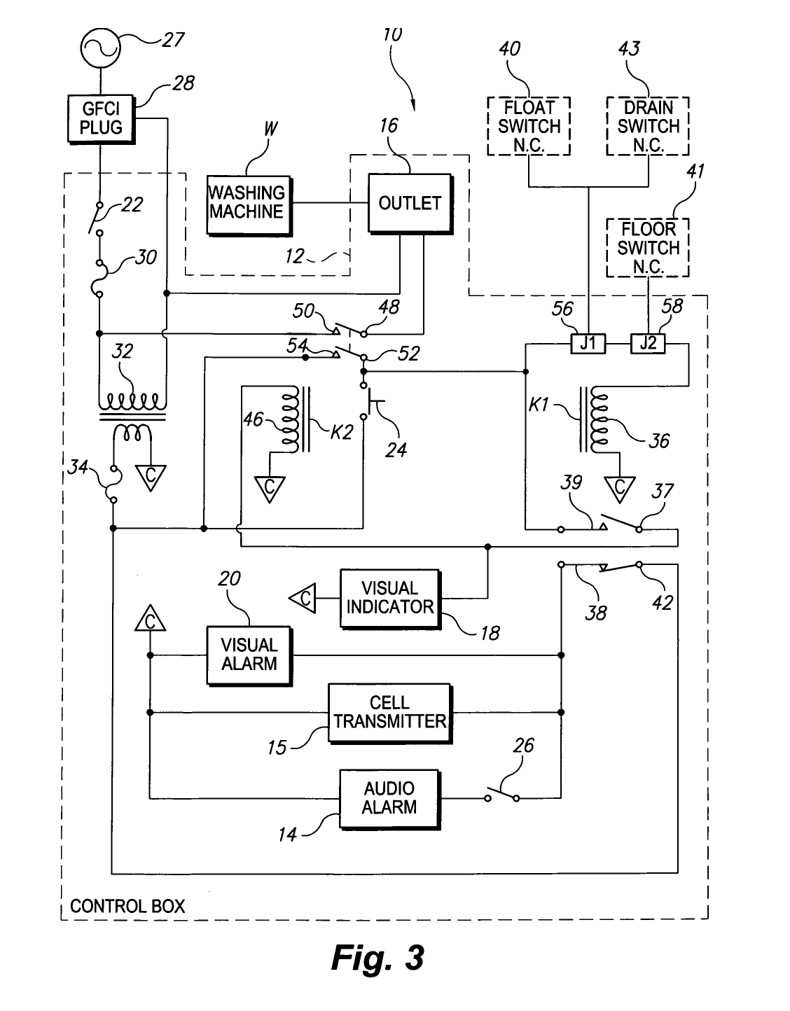

FIG. 3 shows an electrical schematic of an exemplary control circuit housed within control unit 12, together with selected external components. As noted above, the control circuit is preferably connected to the a.c. power mains 27 by GFCI plug 28. The plug 28 is electrically connected to a step-down transformer 32 through the power switch 22 and a primary circuit protection fuse 30. The outlet 16 is electrically connected to the transformer primary through the normally open contacts of a relay, as discussed below.

The step-down transformer 32 steps the 120 volts applied to the transformer primary coil down to 24 volts at the transformer secondary coil. It will be noted that the symbol C shown inside a triangle in FIG. 3 denotes components having a common return to one side of the secondary coil of the transformer 32. Components that derive 24 volts of power from the secondary coil of the transformer 32 are further protected by secondary-fuse 34.

The secondary circuit includes a first relay K1, which may be a double pole, single throw relay having a coil 36, one normally closed contact 38, and one normally open contact 39. One pole 37 of relay K1 is connected to the coil of a second relay, K2, described below. Pole 37 switches the normally open contact 39 to the closed position when the coil 36 is energized. The other pole 42 of relay K1 is electrically connected to the secondary coil of transformer 32 through fuse 34. Pole 42 switches the normally closed contact 38 to the open position when coil 36 is energized. Normally closed contact 38 is electrically connected to one or more of an audio alarm 14; a cell transmitter 15; and a visual alarm 20. Audio alarm 14 may be a bell, a buzzer, or any other audible device (with accompanying circuit, if needed) that can emit an audible alarm, and is mounted within control box 12. Optionally, mute switch 26 is connected in series with the audio alarm 14 so that the audio alarm 14 may be muted while the user or a service technician resolves a flooding or fault condition. The control unit 12 may optionally include cell transmitter 15 for transmitting a pre-recorded alarm message to voice mail by wireless telephony, or may be any other device for transmitting an alarm message or signal to a remote location. Visual alarm indicator 20 may be any device discussed above (with accompanying drive circuit, if needed).

The normally open pole 37 of relay K1 is electrically connected to the power-on visual indicator 18, discussed above. The normally open pole 37 is also connected to the coil 46 of a second relay K2. Relay K2 may be a double-pole, single-throw relay having coil 46, first pole 48, first normally open contact 50, second pole 52, and second normally open contact 54. The first pole 48 is electrically connected to outlet 16, and the first normally open contact 50 is electrically connected to primary fuse 30 so that when the coil 46 is energized, first contact 50 is closed and 120 volts is applied to outlet 16 to provide power for washing machine W.

The second pole 52 and second contact 54 of relay K2 form part of a latching circuit that keeps the coils 36 and 46 of relays K1 and K2 energized during normal operation. The second pole 52 is electrically connected to one side of momentary switch 24. The second pole 52 of relay K2 is also electrically connected to the normally open contact 39 of relay K1. Finally, the second pole 52 of relay K2 is also electrically connected to the coil 36 of relay K1 in series through first jack 56 and second jack 58. The second normally open contact 54 of relay K2 is electrically connected both to the opposite side of momentary switch 24 and to secondary fuse 34.

When power switch 22 is closed and switch 24 is closed momentarily, the coil 36 of relay K1 is energized, closing contact 39 through pole 37. This energizes the coil 46 of relay K2, closing contacts 50 and 54. When momentary switch 24 is released, coil 46 remains energized, since power now flows through the closed contact 54 and the jacks 56, 58 to coil 36, keeping contact 39 closed so that current continues to flow to coil 46. Hence, power remains applied to outlet 16, and the coil 36 of relay K1 also remains energized.

The first jack 56 is a quick-disconnect male-to-female jack. An external sensor switch, either a normally closed float switch 40 or a normally closed drain switch 43, is connected-to the first jack 56 by a mating plug or connector. The effect is to place a normally closed switch, either float switch 40 or drain switch 43, in series between the second pole 52 of relay K2 and the coil 36 of relay K1.

Similarly, the second jack 58 is also a quick-disconnect male-to-female jack. An external sensor switch, normally closed floor switch 41, is optionally connected to the second jack 58 by a mating plug or connector. The effect is to place a normally closed switch in series between the first jack 56 and the coil 36 of relay K1.

In operation, the control box 12 may be mounted on a wall near the washing machine W. The washing machine is plugged into outlet 16. Depending upon the existing waste water discharge set up, a float switch 40 attached to the sink S or a drain switch 43 attached to the drainpipe P by the standpipe, and is connected to the first jack 56 quick-disconnect coupler by a suitable cable. Optionally, a floor-mounted water sensor switch 41 is connected to the second jack 58 quick-disconnect coupler, also by a suitable cable. The GFCI plug 28 is used to connect the control box 12 to the a.c. mains 27, and the GFCI plug reset button is pressed. Power switch 22 is then turned on.

At this point, no power is available at the outlet 16 to power washing machine W. Current flows through the primary coil of transformer 32, inducing a voltage in the secondary coil of the transformer 32, which appears at the open contact 54 of relay K2, while 120 volts appears at the open contact 50 of relay K2. However, current does flow through the secondary coil of the transformer through the pole 42 of relay K1 and the normally closed contact 38 of relay K1 to apply power to visual alarm indicator 20, cell transmitter 15, and audio alarm 14. The power-on visual indicator is off, since the coil of relay K1 is not yet energized and contact 39 is still open. Thus, the control box 12 now shows an alarm-activated state, which is normal upon initial power up.

In order to clear the alarm activated state and place the system into normal operation, the reset button on the GFCI plug 28 is pressed and then the start/reset button 24 is pressed for about 0.5 seconds. When button 24 is pressed, current flows from the secondary coil of the transformer 32 through the switch 24, the first jack 56 and normally closed switch 40 or 43, through the second jack and normally closed switch 41 (when so equipped), and through the coil 36 of relay K1. This closes the normally open contact 39 while opening the normally closed contact 38. Power is removed from the visual alarm indicator 20, cell transmitter 15, and audio alarm 14. At the same time, power is applied to the power-on visual indicator 18, and to the coil of relay K2, closing the normally open contacts 50 and 54. Power is applied to outlet 16 so that the washing machine W may be used, power-on visual indicator 18 turns on, and all alarms are turned off. The relay K2 latches through contacts 54 and 52, keeping the control circuit in this state indefinitely.

This condition continues until one of the water sensor switches 40, 41 or 43 opens (removing power from the coil 36 of relay K1 and the coil of relay K2, re-applying power to the alarms, turning off power to the washing machine W, and again placing the control box 12 in the alarm-activated state), or until a fault trips the GFCI plug, or power is otherwise removed from the control box 12. Power will not be re-applied to the washing machine W until the flooding condition or ground fault is corrected, the reset button on the GFCI 28 is pressed, and momentary switch 24 is pressed for about 0.5 seconds.

The system 10 is a fail safe system, since it uses normally closed switches to detect flood or overflow conditions and automatically shuts down power to the washing machine whenever the switches are cut, broken, activated, or opened for any reason. It will be understood that the system 10, although described with respect to a washing machine might also be used with a hot tub, sauna, or other appliance where flooding or overflow might occur. It will further be understood that the embodiments of the invention disclosed herein are exemplary, and other circuit configurations may be used in lieu thereof. For example, in some embodiments triacs or transistor switches may replace the mechanical relays in the latching circuit.

It is to be understood that the present invention is not limited to the embodiments described above, but encompasses any and all embodiments within the scope of the following claims.

I claim:

1. A washing machine flood prevention system, comprising:
a control box and a control circuit housed in the control box, the control circuit including an alarm and a power outlet adapted for receiving an electrical power cord plug of a washing machine;
a water level sensor electrically connected to the control circuit, the control circuit being configured to activate the alarm and to interrupt power to the power outlet when the water level sensor detects flooding of waste water from the washing machine; and
a ground fault circuit interrupter electrically connected to the control circuit for interrupting power to the control circuit and to the power outlet when a ground fault occurs.

2. The washing machine flood prevention system as recited in claim 1, wherein said water level sensor comprises a normally closed float switch adapted for sensing water level in a sink receiving waste water from the washing machine.

3. The washing machine flood prevention system as recited in claim 1, wherein the alarm comprises an auditory alarm.

4. The washing machine flood prevention system as recited in claim 3, wherein the alarm further comprises a visual alarm.

5. The washing machine flood prevention system as recited in claim 4, wherein the alarm further comprises a wireless transmitter adapted for sending a cellular alarm signal.

6. The washing machine flood prevention system as recited in claim 1, wherein the control circuit further comprises a visual power indicator.

7. The washing machine flood prevention system as recited in claim 6, wherein the control circuit further comprises a control switch for selectively activating and deactivating the control circuit.

8. The washing machine flood prevention system as recited in claim 7, wherein the control circuit comprises a reset switch and a latching circuit connected to the reset switch, the reset switch being a momentary switch, the latching circuit being configured for turning off the alarm and applying power to the power outlet until the water level sensor detects a flood condition or until a ground fault interrupts power when the reset switch is pressed momentarily.

9. The washing machine flood prevention system as recited in claim 8, wherein the control circuit further comprises means for selectively activating and deactivating the alarm.

10. The washing machine flood prevention system as recited in claim 1, wherein the control circuit further comprises a step-down transformer.

11. The washing machine flood prevention system as recited in claim 10, wherein the control circuit further comprises at least one fuse.

12. A flood prevention system, comprising:
a normally closed water level sensor switch;
a control box;
an alarm circuit for producing an alarm, the alarm circuit being housed in the control box;
a power outlet mounted on the control box, the power outlet being adapted for supplying power to an appliance, the appliance being capable of discharging water to produce flooding conditions;
a control circuit for interrupting power to the power outlet and for activating the alarm circuit to produce the alarm when the water level sensor switch detects the flooding conditions, the control circuit being housed in the control box, the control circuit including a momentary reset switch and a latching circuit electrically connected to the latching circuit, the latching circuit being configured for deactivating the alarm circuit and applying power to the power outlet until the water level sensor detects the flooding conditions.

13. The flood prevention system as recited in claim 12, further comprising a power cord electrically connected to the control circuit for applying power to the control circuit, the power cord having a ground fault circuit interrupter plug adapted for connection to an a.c. power main.

14. The flood prevention system as recited in claim 12, wherein said alarm circuit includes an alarm selected from the group consisting of a visual alarm indicator mounted on the control box, an audible alarm, and a cellular transmitter programmed to transmit a pre-recorded alarm message to a remote location when the alarm circuit is activated.

15. The flood prevention system as recited in claim 12, wherein said alarm circuit comprises an audible alarm and a mute switch in series with the audible alarm, the mute switch permitting muting the audible alarm pending clearing of the flooding conditions and resetting the control circuit.

16. The flood prevention system as recited in claim 12, wherein the water level sensor switch comprises a float switch.

17. The flood prevention system as recited in claim 12, wherein said latching circuit comprises a relay having at least one normally open set of contacts configured with said momentary switch to form said latching circuit.

18. The flood prevention system as recited in claim 17, wherein said relay comprises a double-pole single-throw relay having a second normally open set of contacts in series with said power outlet, the second set of contacts being latched closed to supply power to said power outlet when said relay is energized.

19. The flood prevention system as recited in claim 12, further comprising a power-on visual indicator mounted on said control box and an alarm visual indicator mounted on said control box, said control circuit being configured for turning on the power-on visual indicator and turning off the alarm visual indicator when power is applied to said power outlet and no flooding condition is sensed by said water level sensor, said control circuit further being configured for turning off the power-on visual indicator and turning on the alarm visual indicator when power to said power outlet is interrupted.

20. The flood prevention system as recited in claim 19, wherein said alarm visual indicator is selected from the group consisting of a flashing light and a continuously illuminated light.
